(19) United States
(12) Patent Application Publication
(10) Pub. No.: US 2005/0095544 A1
(43) Pub. Date: May 5, 2005

(54) Evaporator arrangement for generating a hydrocarbon/air or hydrocarbon/steam mixture that can be decomposed in a reformer for producing hydrogen and process for operating such an evaporator arrangement

(76) Inventors: Andreas Kaupert, Ulm (DE); Gunter Eberspach, Wolfschlugen (DE)

Correspondence Address: MCGLEW & TUTTLE, PC, 1 SCARBOROUGH STATION PLAZA, SCARBOROUGH, NY, 10510-0827, US

(21) Appl. No.: 10/945,029

(22) Filed: Sep. 20, 2004

(30) Foreign Application Priority Data
Oct. 15, 2003 (DE) 103 48 637.2

(51) Int. Cl. F23Q 7/08

(52) U.S. Cl. 431/262

(57) ABSTRACT

An evaporator arrangement is provided for generating a hydrocarbon/air or/and hydrocarbon/steam mixture that can be decomposed in a reformer for producing hydrogen. A burner/evaporator area, which has a combustion/mixing chamber (14), into which air or/and steam enters via an inlet opening arrangement (16), a hydrocarbon-evaporating device (24, 34), including a porous evaporator medium (24) and, associated with same, a first heating device (34) and a glow type igniting member (28) for igniting a hydrocarbon-containing mixture present in the combustion/mixing chamber (14).

### CROSS REFERENCE TO RELATED APPLICATIONS

This application claims the benefit of priority under 35 U.S.C. § 119 of DE 103 48 637.2 filed Oct. 15, 2003, the entire contents of which are incorporated herein by reference.

### FIELD OF THE INVENTION

The present invention pertains to an evaporator arrangement for generating a hydrocarbon/air or hydrocarbon/steam mixture that can be decomposed in a reformer for producing hydrogen and to a process for operating such an evaporator arrangement.

### BACKGROUND OF THE INVENTION

Reformers are used to split hydrocarbons or materials containing hydrocarbons in a catalytic reaction and to release or produce hydrogen in the process. This hydrogen can be used, for example, in fuel cells for generating electric energy, or it can be used in an exhaust gas guiding system of an internal combustion engine for treating exhaust gases. To make it possible to convert the mixture fed to a catalytic material in such reformers or to start and maintain the catalytic reaction, it is necessary to bring the area of the reformer, i.e., essentially the assembly units that come into contact with the mixture and also the catalytic material, as well as the mixture to a certain operating temperature. The temperature for producing hydrogen from a diesel vapor/air mixture is in the range of 320° C. for starting the catalytic reaction. Once this reaction has been started, it can be continued at a temperature of about 240° C. However, this means that especially in case of use in motor vehicles, the heating of the relevant areas of the system from comparatively low temperatures, which may be in the range of down to −40° C., to these comparatively high operating temperatures must take place as quickly as possible. It is known, in general, that the essential components of the system are heated for this purpose and the energy for evaporating the fuel or hydrocarbon, which is present, in general, in the liquid form, is also obtained by loading the onboard power supply system of the vehicles. However, this represents a very high load on the onboard power supply system, as a consequence of which the time elapsing until the necessary temperatures are reached may be very long because of the limited performance capacity.

### SUMMARY OF THE INVENTION

The object of the present invention is to make available an evaporator arrangement for generating a hydrocarbon/air or hydrocarbon/steam mixture that can be decomposed in a reformer for producing hydrogen, as well as a process for starting such an evaporator arrangement, in which evaporator arrangement and process the time needed to reach the operating temperatures necessary especially in the area of a catalytic material is kept short.

According to a first aspect of the present invention, this object is accomplished by an evaporator arrangement for generating a hydrocarbon/air or hydrocarbon/steam mixture that can be decomposed in a reformer for producing hydrogen, comprising a burner/evaporator area with a combustion/mixing chamber, into which air or/and steam enters via an inlet opening arrangement, a hydrocarbon-evaporating device, comprising a porous evaporator medium and, associated with same, a first heating device as well as a glow type igniting member for igniting a hydrocarbon vapor-containing mixture present in the combustion/mixing chamber.

It is essential in the present invention that not only is the thermal energy provided to reach the operating temperatures especially also in the area of the catalytic material of the reformer by, e.g., heaters that can be operated electrically, but a mixture proper that can be decomposed to produce hydrogen is first burned in the evaporator arrangement. High temperatures are generated during this combustion, so that the combustion waste gases flowing in the direction of the catalytic material or to the system components of the reformer that are present there also contribute to the very rapid heating there. It was found that heating from very low start temperatures to the temperatures necessary for the operation in the range above 300° C. can be achieved with this arrangement according to the present invention in less than 15 to 30 seconds.

Provisions may be made in the arrangement according to the present invention, e.g., for the hydrocarbon-evaporating device to be arranged in a bottom area of the combustion/mixing chamber. Furthermore, it is also possible for the inlet opening arrangement to be formed in a wall area surrounding the combustion/mixing chamber. In order to start the combustion especially in the area in which a high concentration of combustible fuel, i.e., hydrocarbon, is present, it is proposed that the glow type igniting member be elongated and extend at a spaced location from the hydrocarbon-evaporating device approximately in parallel to same.

The first heating device can be preferably operated electrically.

According to another advantageous aspect, a second heating device may be provided for heating a wall surrounding the combustion/mixing chamber or/and a wall adjoining the combustion/mixing chamber in the direction of flow.

Since very high temperatures occur, for example, in a fuel cell or even in an exhaust gas guiding system of an internal combustion engine in various areas, it is proposed according to another aspect of the present invention for the second heating device to comprise a heat exchanger arrangement through which heated fluid can flow or/and a heating element that can be operated electrically. The heated fluid mentioned may then be heated in the areas in which high temperatures develop, e.g., due to exothermic reactions taking place.

According to another aspect of the present invention, the object described in the introduction is accomplished by a process for starting an evaporator arrangement for generating a hydrocarbon/air or/and hydrocarbon/steam mixture that can be decomposed in a reformer for producing hydrogen, comprising the steps:
a) Heating and evaporating liquid hydrocarbon or hydrocarbon-containing liquid,
b) mixing of the vapor generated in step a) with air,
c) ignition of the mixture generated in step b) to start a mixture combustion,
d) maintenance of the combustion until the end of a predetermined time or/and until a predetermined temperature is present in one or more predetermined areas of the system, and
e) termination of the combustion after the end of the predetermined time or/and after the predetermined temperature has been reached.

Consequently, an evaporator arrangement is operated according to the present invention such that a mixture proper that can be decomposed for producing hydrogen is first burned, and the combustion is then set when the system components operating to produce hydrogen, i.e., especially the system area of the reformer containing the catalyst, are in the state in which the catalytic reaction can take place.

Provisions may be made, for example, for activating a heating device that can be operated preferably electrically for the evaporation. This heating device is preferably continued to be activated at least during the steps c) and d).

To make it possible to end the combustion when the thermal states necessary for the catalytic reaction to take place are reached, it is proposed that the supply of liquid hydrocarbon or of the hydrocarbon-containing liquid be throttled or interrupted in step e) or/and that the supply of air be throttled or interrupted. The catalytic reaction can be continued or started by continuing or resuming the supply of liquid hydrocarbon or of the hydrocarbon-containing liquid and the supply of air or/and steam for generating the mixture that can be decomposed for producing hydrogen.

A procedure in which steam is supplied instead of or in addition to the supply of air after the termination of the combustion in step e) proved to be especially advantageous in terms of efficiency for the conversion of the mixture produced into hydrogen or a hydrogen-containing gas that can be used in a fuel cell. Consequently, a mixture or steam mixture containing essentially evaporated hydrocarbon or evaporated water is thus generated, and, as was already described above, the supplying of the hydrocarbon vapor can be ensured above all by operating the heating device that can be operated electrically. It shall be pointed out here that, for example, small quantities of steam may, of course, already also be added during a phase during which the following components of the system, e.g., the reformer and optionally also a fuel cell, are to be heated by burning the mixture containing hydrocarbon vapor. It is also possible to mix not only hydrocarbon vapor and steam after this phase of heating and during the phase during which reformate, i.e., hydrogen-containing gas, is produced, but to also to add a certain percentage of air here.

In order to load the onboard power supply system of a vehicle as little as possible during the catalytic reaction, it is proposed that the heating device, which is activated at least until the combustion is generated, is not activated in or/and after step e).

Furthermore, it may be proposed in the process according to the present invention that fossil or nonfossil fuel, preferably diesel fuel, gasoline, biodiesel or the like, be used as the liquid hydrocarbon or hydrocarbon-containing liquid.

Furthermore, provisions may be made in the process according to the present invention for introducing waste gases, which are formed in a burner during the combustion of residual reformate leaving a fuel cell, into the evaporator arrangement instead of or in addition to the supply of air or/and steam. The efficiency of the reformate production can be increased by returning a certain percentage of the reformate produced in a reformer and of the combustion waste gases that are formed when the residual reformate leaving the fuel cell, i.e., a gas containing a certain percentage of residual hydrogen, is burned in a burner. Furthermore, cooling of the catalytic material in the reformer can be achieved, especially if these gases fed additionally into the starting material for producing reformate are first sent over a heat exchanger arrangement and they release heat there. Such heat exchangers can be used to transfer the heat released there to water to evaporate the water and then to mix this steam, as was described above, with hydrocarbon vapor for producing reformate. The heat transported in the reformate or in the waste gases mentioned may be used in heat exchangers to generate steam regardless of whether these gases, i.e., the reformate or the waste gases, are returned into the process.

Furthermore, the present invention pertains to a reformer for producing hydrogen from a hydrocarbon/air or/and hydrocarbon/steam mixture, comprising an evaporator arrangement according to the present invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic longitudinal sectional view of an evaporator arrangement according to the present invention; and

FIG. 2 is a block diagram of a reformer system in conjunction with an evaporator arrangement according to the present invention.

### DESCRIPTION OF THE PREFERRED EMBODIMENTS

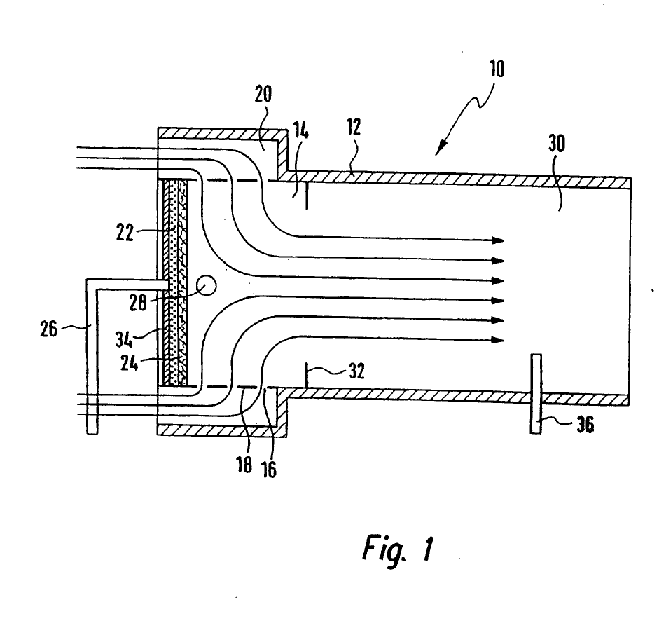

An evaporator arrangement according to the present invention is generally designated by 10 in FIG. 1. The evaporator arrangement 10 comprises an elongated, tubular housing arrangement 12, in which a mixture of evaporated fuel, for example, diesel fuel, and air is formed, as will be described below. A combustion/mixing chamber 14, to which the air is supplied from a radially outer, annular space 20 via a plurality of inlet openings 16 in an outer circumferential wall 18, is provided in the housing 12 for this purpose. A porous evaporator medium 24, which may be formed, for example, by a nonwoven material or a fabric or a mat-like material, foamed ceramic or the like, is provided at a bottom area 22 of the combustion/mixing chamber 14. A fuel supply line 26 passes through the bottom area 22 and introduces the fuel to be evaporated into the porous evaporator medium 24. An igniting member 28 of a pin-like design, for example, a glow type ignition pin, is located at an axially spaced location in relation to a direction of gas flow within the tubular housing 12 toward the bottom area 22 or the evaporator medium 24 arranged thereon. This igniting member 28 extends at right angles to the said longitudinal or axial direction and is essentially parallel to the bottom area 22 or the side of the evaporator medium 24, which said side faces the combustion/mixing chamber 14. The fuel/air or/and fuel/steam mixture, which is formed in the combustion/mixing chamber 14 by the supply of air, on the one hand, and by the evaporation of the fuel, on the other hand, and which can also be considered to be a hydrocarbon/air or/and hydrocarbon/steam mixture, leaves the combustion/mixing chamber 14 and enters a volume area 30 in which the catalytic material of a reformer, not shown in the figure, may be arranged. The mixture leaving the combustion/mixing chamber through a diaphragm 32 and flowing toward the catalyst is split at the catalyst by a catalytic reaction in order to produce hydrogen. This hydrogen can then be subjected to further use, for example, in a fuel cell for producing electric energy or in an exhaust gas guiding system of an internal combustion engine for exhaust gas cleaning.

To make it possible to carry out the catalytic reaction in such a reformer, it is necessary that not only the mixture that is to be converted in this catalytic reaction but also the different system components, for example, the catalytic material, the wall material surrounding same and the like, have a certain temperature. For example, it may be necessary in case of the use of a diesel/air mixture to provide for heating to about 320° C. here to start the catalytic reaction. Once this reaction has been started, it can then continue at a temperature of about 240° C. These high temperatures require, especially for starting the catalytic reaction, the introduction of a comparatively large amount of energy to generate the necessary heating. It shall be pointed out that such systems are used, for example, in vehicles and these must also be able to operate at outside temperatures in the range of down to −40° C. Consequently, this device that heating of the different system components over a temperature range of nearly 400° C. must be achieved in a comparatively short time.

The manner in which this heating is accomplished in the evaporator arrangement according to the present invention will be described below.

It is recognized in the figure that a heating device 34 is provided at the bottom area 22. This can preferably be operated electrically and comprises a heating coil or the like, which is located on the side of the bottom area 22 facing away from the combustion/mixing chamber 14 in the example being shown. It is, of course, also possible to position this heating device 34 between the bottom area 22 and the porous evaporator medium 24 in order to achieve an even more efficient introduction of heat into this porous evaporator medium. By exciting the heating device 34, the temperature can consequently be raised in the area of the porous evaporator medium 24, so that the evaporation of the fuel fed in via the line 26 will occur increasingly there. As was mentioned above, a mixture of air and fuel vapor, which is highly enriched with fuel, is now formed in the combustion/mixing chamber 14, and this procedure is preferably carried out such that a lean mixture in the range of λ=2 will become established.

However, the amount of heat introduced by the heating device 34 would not be sufficient to bring the overall system, especially the area of the system located near the catalyst, to the necessary temperatures. The procedure is therefore carried out according to the present invention at the time of the start-up of such an evaporator arrangement 10 or a reformer for producing hydrogen such that the fuel/air mixture generated in the combustion/mixing chamber 14 is ignited by exciting the igniting member 28. The igniting member 28 may be activated simultaneously with the excitation of the heating device 34, but it may also be activated only when a sufficient amount of fuel vapor is present in the combustion/mixing chamber 14 after the activation of the heating device 34. Since the igniting member 28 is positioned in an area located close to the porous evaporator medium 24, it acts in an area in which a comparatively high percentage of fuel vapor will be present, so that the combustion will develop rapidly and propagate rapidly over the entire area of the combustion/mixing chamber 14 due to the air flowing in via the openings 16. The combustion flame and the hot combustion waste gases are entrained with the flow through the diaphragm 32 and thus they enter the volume area 30. They contribute there to the heating of the system components located there, especially also to the heating of the catalytic material, very effectively and rapidly. It was found that the temperatures necessary for starting the reaction taking place at the catalyst can thus be reached in about 15 to 30 sec.

If the necessary temperatures are present in the system area that is essential for the catalytic reaction, which can either be detected by device of a temperature sensor 36 or ensured by presetting a predetermined combustion time, the combustion is terminated. This can be achieved by interrupting or reducing the fuel supply or/and the air supply into the combustion/mixing chamber 14 for a short period of time. After the combustion flame has gone out, the fuel supply or the air supply or/and the steam supply is resumed, so that the hydrocarbon/air mixture to be converted in the reformer, which will reach the catalytic material in the unburned state, will now be generated in the range of λ=0.4. Since this catalytic material was heated by the hot combustion waste gases immediately before to the necessary temperatures, the catalytic reaction for producing hydrogen will start.

In the procedure according to the present invention, which was described above, the heating device 34 may be operated in order to achieve the most rapid propagation possible of the combustion and consequently also the most rapid heating possible of the essential system areas, until the combustion is terminated by the above-described procedures after the predetermined temperatures have been reached. It is, of course, also possible to switch off the heating device 34 to save electric energy when the combustion had already been started by exciting the glow type igniting member 28. Very rapid propagation of the combustion will occur in this case as well, because very high temperatures, which support the evaporation of initially still liquid fuel from the porous medium 24, also occur above all in the area of the combustion/mixing chamber 14 due to the combustion. After the termination of the combustion, the heating device 34 is preferably not put into operation any longer in order not to excessively load the onboard power supply system especially in case of use in a vehicle. The heating of the mixture to be generated in the combustion/mixing chamber 14 can then be achieved during this phase, for example, by producing heat from the processes taking place, for example, in a fuel cell or from the processes taking place in the catalyst of the reformer, which heat is then transferred via a heat transfer fluid and corresponding heat exchanger arrangements to the housing 12. It may be advantageous in case of the use of high-boiling fuels, e.g., diesel fuel, to also continue to operate the heating device 34 during the reforming process, i.e., after the combustion had already been terminated, to support the evaporation of the fuel, or to put it into operation again. It is, of course, also possible to provide another heating device, for example, a heating device that can be operated electrically, in the area of the housing 12, in order to maintain the catalytic reaction at, e.g., very low outside temperatures. In case of use in conjunction with an exhaust gas guiding system of an internal combustion engine, it is, of course, possible to allow the exhaust gases released by the internal combustion engine to flow around the housing 12 or to extract these exhaust gases and to transfer them to the housing 12.

Various measures may be taken in the device according to the present invention and the procedure according to the present invention to increase the efficiency during the production of reformate, i.e., the conversion of the hydrocarbon-containing mixture into a hydrogen-containing gas. For example, provisions may be made to mix the hydrocarbon vapor with steam which may optionally contain a certain percentage of air, instead of with air, when the desired operating temperature of the catalytic material has been reached, i.e., when the combustion has been terminated and the hydrocarbon-containing mixture is now flowing in the direction of the reformer. The steam may be introduced into the combustion/mixing chamber 14 in a corresponding manner, as was described above in reference to FIG. 1 and concerning the introduction of air, and mixed with the hydrocarbon vapor evaporating from the evaporator medium 24 there. Such a mixture of hydrocarbon vapor with a high percentage of steam leads to a markedly higher yield during the production of the hydrogen-containing gas. Furthermore, it is possible to feed back reformate generated in the reformer, i.e., hydrogen-containing gas, and additionally introduce it into the combustion/mixing chamber 14. It is also possible to introduce waste gases that are formed during the combustion of residual hydrogen leaving the fuel cell into the combustion/mixing chamber 14.

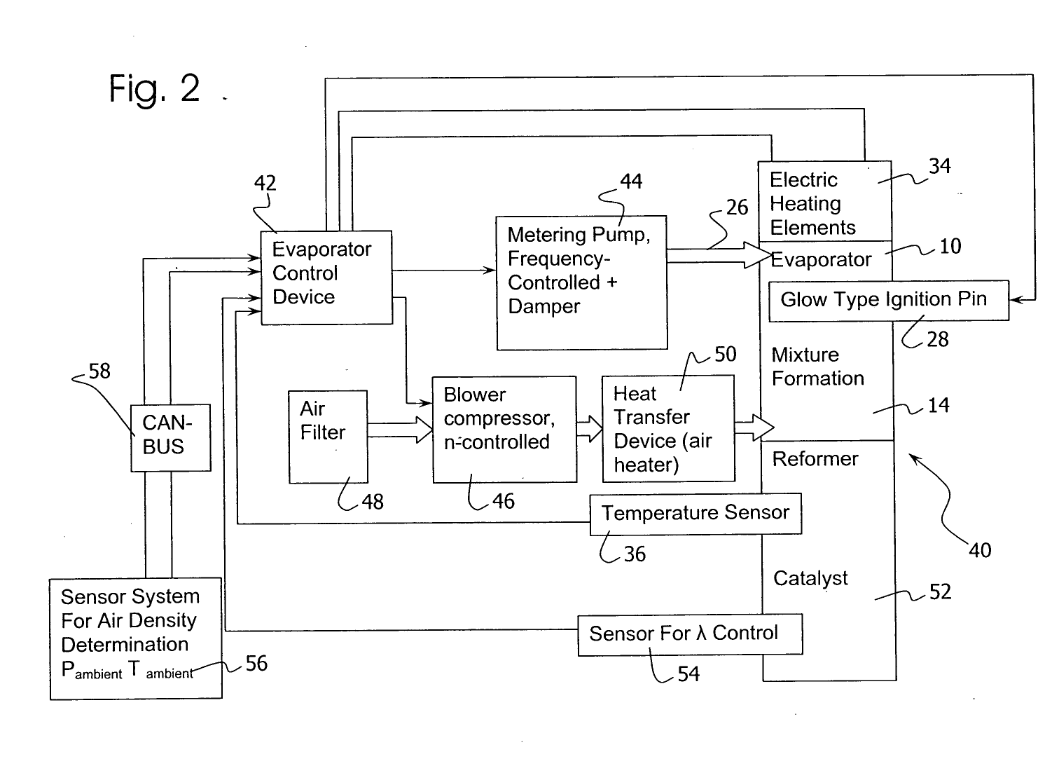

As was also described above, the heat generated in different system areas, which will also be described below in reference to FIG. 2, i.e., for example, the heat transported in the reformate or the heat generated during the combustion of residual hydrogen after a fuel cell, may be utilized to preheat various system areas. At the same time, this heat may also be utilized to heat air or/and to evaporate water and thus to make available the steam. It is, of course, also possible to provide separate heating and burner arrangements for this.

Furthermore, it may be advantageous to send the steam or preheated air past on the side of the bottom area 22 of the housing 12 facing away from the combustion/mixing chamber 14 and thus to also preheat this bottom area 22. This reduces the heat output to be provided in the area of the heating device 34. However, it should be ensured in this case, especially if gasoline is used as the hydrocarbon, that such a preheating of the fuel line 26 will not occur.

FIG. 2 shows a reformer system 40, in which the evaporator arrangement 10 according to the present invention is used. The heating device 34, which is controlled by a control device 42, is also recognized in the evaporator arrangement 10 in FIG. 2. A metering pump 44, which is likewise under the control of the control device 42, feeds the fuel or hydrocarbon to be evaporated into the combustion/mixing chamber 14 via the line 26, and this feed may be performed in a frequency-controlled, i.e., cycled manner. A damper, i.e., an intermediate storage device, from which the liquid being delivered is then released in the direction of the combustion/mixing chamber 14 in a more or less continuous manner, may be associated with the metering pump 44. A blower 46, which is likewise under the control of the control device 42, takes up air via an air filter 48 and feeds same, optionally after it passes through a heat exchanger 50, into the combustion/mixing chamber 14 in a preheated manner to form a mixture. The glow type ignition pin 28, which acts as an igniting member and ignites the fuel/air mixture formed in the combustion/mixing chamber 14, can also be recognized. The reformer part 52 of the reformer system 40 with the catalytic material is located downstream of the combustion/mixing chamber 14. The temperature sensor 36 is also provided in this area. Furthermore, a lambda sensor 54 may be provided, which is used, as was already described above, to set the fuel-to-air ratio during different phases of the operation such that a desired lambda value will be obtained.

The different control measures performed by the control device 42 take place with the involvement of different parameters, e.g., the temperature detected by the temperature sensor 36, the initial value of the lambda sensor 54 as well as various other sensors, which deliver data that are relevant for the operation of the system 40. This may also be, for example, a sensor system for the correct setting of the mixture, by which the ambient pressure and the ambient temperature are optionally detected for determining the density of the air, and whose data are introduced into the control device 42 via a data bus system 58.

The system shown in FIG. 2 can then be operated as was already described above in reference to FIG. 1 for starting, on the one hand, and for producing hydrogen, on the other hand.

The present invention provides for an evaporator arrangement and a process for starting same and a process for starting a reformer for producing hydrogen, which ensure with a comparatively simple design that the temperatures necessary for carrying out the catalytic reaction can be reached in a very short time without excessively loading the onboard power supply system. The present invention benefits essentially from the fact that the mixture to be decomposed in the reformer is combustible itself, so that even though no catalytic reaction is carried out in a short period of the start phase, the basic material actually used to produce hydrogen is burned in order to bring the reformer system and the fuel cell system to the necessary temperatures.

It shall finally be pointed out that whenever a hydrocarbon/air mixture or a hydrocarbon/steam mixture is referred to in this text, this does not rule out the addition to this mixture of other substances, for example, steam in the first example and air in the second example. It shall only be expressed that the particular mixture-forming components mentioned specifically are present in any case.

While specific embodiments of the invention have been shown and described in detail to illustrate the application of the principles of the invention, it will be understood that the invention may be embodied otherwise without departing from such principles.

1. An evaporator arrangement for generating a hydrocarbon/air or/and hydrocarbon/steam mixture that can be decomposed in a reformer for producing hydrogen, the arrangement comprising:
a burner/evaporator area including:
a combustion/mixing chamber into which air or/and steam enters via an inlet opening arrangement;
a hydrocarbon-evaporating device comprising a porous evaporator medium and a first heater associated therewith, and
a glow type igniting member for igniting said hydrocarbon-containing mixture present in said combustion/mixing chamber.

2. An evaporator arrangement in accordance with claim 1, wherein said hydrocarbon-evaporating device is arranged in a bottom area of said combustion/mixing chamber.

3. An evaporator arrangement in accordance with claim 1, wherein said inlet opening arrangement is formed in a wall area surrounding said combustion/mixing chamber.

4. An evaporator arrangement in accordance with one of the claim 1, wherein said glow type igniting member is elongated and extends at a spaced location from said hydrocarbon-evaporating device approximately in parallel to same.

5. An evaporator arrangement in accordance with claim 1, wherein said first heating device is operated electrically.

6. An evaporator arrangement in accordance with claim 1, further comprising a second heating device for heating a wall surrounding said combustion/mixing chamber or/and a wall adjoining said combustion/mixing chamber in the direction of flow.

7. An evaporator arrangement in accordance with claim 6, wherein said second heating device comprises a heat exchanger arrangement through which heated fluid can flow or/and a heating element that can be operated electrically.

8. A process for starting an evaporator arrangement for generating a hydrocarbon/air or/and hydrocarbon/steam mixture that can be decomposed in a reformer for producing hydrogen, especially an evaporator arrangement in accordance with one of the above claims, comprising the steps:
a) heating and evaporating liquid hydrocarbon or hydrocarbon-containing liquid;
b) mixing of the steam generated in step a) with air;
c) igniting of the mixture generated in step b) for starting the combustion of the mixture;
d) maintaining the combustion until the end of a predetermined period of time or/and until a predetermined temperature is reached in one or more predetermined areas of the system;
e) terminating the combustion after the end of the predetermined period of time or/and after the predetermined temperature has been reached.

9. A process in accordance with claim 8, wherein a heating device that can be preferably operated electrically is activated for the evaporation.

10. A process in accordance with claim 9, wherein said heating device remains activated at least during the steps c) and d).

11. A process in accordance with claim 8, wherein the supply of liquid hydrocarbon or of the hydrocarbon-containing liquid is throttled or interrupted or/and the supply of air is throttled or interrupted in step e).

12. A process in accordance with claim 11, wherein after the termination of the combustion in step e), the supply of liquid hydrocarbon or of the hydrocarbon-containing liquid and the supply of air or/and steam for generating the mixture that can be decomposed to produce hydrogen is continued or resumed.

13. A process in accordance with claim 8, wherein steam is supplied instead of or in addition to the supply of air after the termination of the combustion in step e).

14. A process in accordance with claim 8, wherein said heating device is activated at least until the combustion is generated and is not activated in or/and after step e).

15. A process in accordance with claim 8, wherein fossil or nonfossil fuel is used as the liquid hydrocarbon or hydrocarbon-containing liquid.

16. A process in accordance with claim 15, wherein one or more of diesel fuel, gasoline, biodiesel or the like, is used as the liquid hydrocarbon or hydrocarbon-containing liquid.

17. A process in accordance with claim 8, wherein instead of or in addition to the supply of air or/and steam, reformate generated in the reformer or/and waste gases are introduced into the evaporator arrangement, which said waste gases are formed during the combustion of residual reformate leaving a fuel cell in a burner.

18. A reformer for producing hydrogen from a hydrocarbon/air or/and hydrocarbon/steam mixture, comprising:
a bumer/evaporator area including:
a combustion/mixing chamber into which air or/and steam enters via an inlet opening arrangement;
a hydrocarbon-evaporating device comprising a porous evaporator medium and a first heater associated therewith, and
a glow type igniting member for igniting said hydrocarbon-containing mixture present in said combustion/mixing chamber.
